(19) United States
(12) Patent Application Publication
(10) Pub. No.: US 2006/0245218 A1
(43) Pub. Date: Nov. 2, 2006

(54) Driving synchronous rectifiers across the isolation barrier

(75) Inventor: Steven James Tumasz, Chichester, NH (US)

Correspondence Address: HARNESS, DICKEY & PIERCE, P.L.C., P.O. BOX 828, BLOOMFIELD HILLS, MI, 48303, US

(73) Assignee: Astec International Limited, Kwun Tong, Kowloon (HK)

(21) Appl. No.: 11/116,767

(22) Filed: Apr. 28, 2005

(51) Int. Cl. H02M 7/04

(52) U.S. Cl. 363/89

(57) ABSTRACT

A switching power supply circuit has a power transformer having a core, a primary winding, and a secondary winding. A first switch has a control signal input and is connected to the primary winding of the power transformer. A synchronous rectifier has a control signal input and is connected to the secondary winding of the power transformer. A signal transformer has a primary winding and a secondary winding, and a first connection has a first end connected to the control signal input of the first switch and a second end connected to the primary winding of the signal transformer.

### FIELD OF THE INVENTION

The present invention relates generally to switching power supplies having a synchronous rectifier, and more particularly to circuits for driving the synchronous rectifier.

### BACKGROUND OF THE INVENTION

In the art of switching power supplies it is known to use a synchronous rectifier and a synchronous free-wheeling switch to increase the efficiency of the power supply. The switching power supplies commonly have a transformer with a single primary winding and two secondary windings. The first secondary winding provides power for rectification and supplying a load. The second, or auxiliary, secondary winding provides a signal for controlling the synchronous rectifier and the free-wheeling switch.

As power supplies continue decreasing size there is often insufficient space available for a transformer with two secondary windings. In power supplies having a planar power transformer, the width of the circuit board may be consumed by the primary winding and main secondary winding, leaving minimal space for the auxiliary secondary winding. As such, a need has developed in the art for an alternative method of developing switch drive signals in a self-driven synchronous rectifier switching power supply.

### SUMMARY OF THE INVENTION

This invention is directed to a switching power supply circuit having a first transformer with a core, a primary winding, and a secondary winding. A first switch has a control signal input and is connected to the primary winding of the first transformer. A synchronous rectifier has a control signal input and is connected to the secondary winding of the first transformer. A second transformer has a primary winding and a secondary winding. A first connection has a first end connected to the control signal input of the first switch and a second end connected to the primary winding of the second transformer.

In another aspect, a printed circuit board has a power transformer with a primary winding, a secondary winding, and a core region. A first switch footprint has a first control signal pad and is connected to the primary winding of the power transformer. A synchronous rectifier footprint has a second control signal pad and is connected to the secondary winding of the power transformer. A signal transformer footprint has primary winding pads and secondary winding pads, and a first trace is connected between the first control signal pad and one of the primary winding pads of the signal transformer footprint.

In yet another aspect, a switching power supply circuit has a first transformer with a core, a primary winding with first and second ends, and a secondary winding with first and second ends. A first primary switch has a first control signal input and is connected to the first end of the primary winding of the first transformer. A second primary switch has a second control signal input and is connected to the second end of the primary winding of the first transformer. A synchronous rectifier has a rectifier control signal input and is connected to the first end of the secondary winding of the first transformer. A freewheeling switch has a control signal input and is connected to the second end of the secondary winding of the first transformer. A second transformer has a primary winding with a first end and a second end, and a secondary winding with a first end and a second end. A first conductor connects the first control signal input and the first end of the primary winding of the second transformer; and a second conductor connects the second control signal input and the second end of the primary winding of the second transformer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts a schematic diagram of a switching power supply of the present invention; and

FIG. 2 depicts a plan view of a printed circuit board.

### DETAILED DESCRIPTION OF THE PREFERRED EMBODIMENTS

The following description is merely exemplary in nature and is in no way intended to limit the invention, its application, or uses.

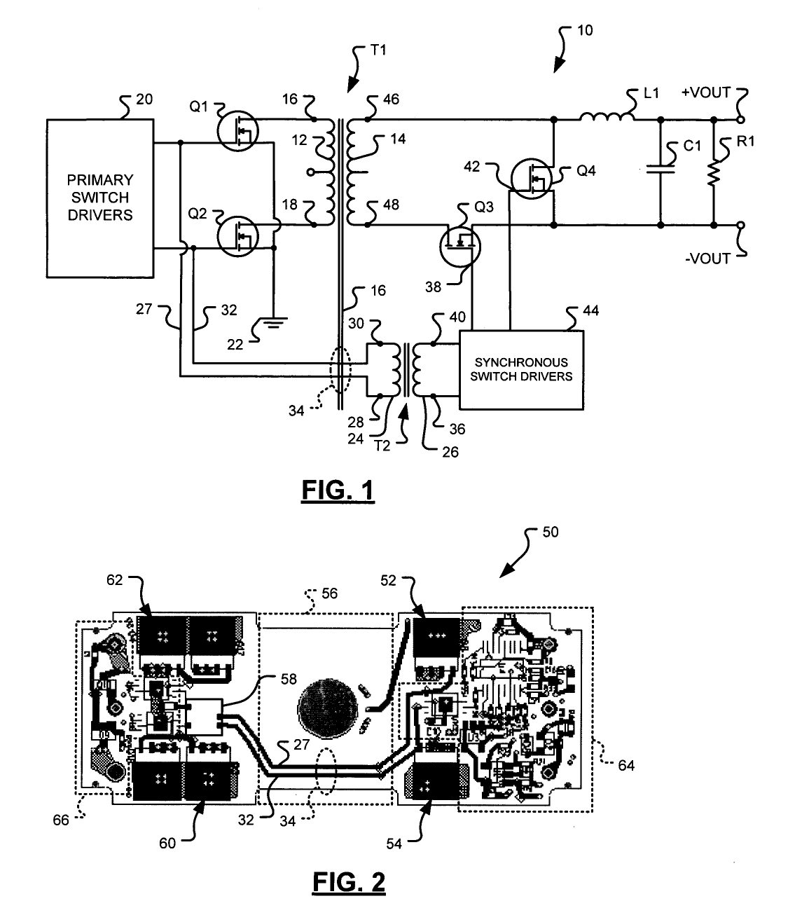

FIG. 1 shows one of various embodiments of a switching power supply 10. The power supply 10 has a power transformer T1, such as a planar or wire wound transformer, having a primary winding 12 and a secondary winding 14. A core 16 couples magnetic flux between the primary winding 12 and the secondary winding 14. In some embodiments, the power transformer T1 is of a planar design. The primary winding 12 has a first end 16 connected to a first primary switching transistor Q1. A second end 18 of the primary winding 12 is connected to a second primary switching transistor Q2. A gate of the switching transistor Q1 and a gate of the switching transistor Q2 are connected to primary switch drivers 20 as is known in the art. A source of the first primary switching transistor Q1 and a source of the second primary switching transistor Q2 are connected to ground 22.

A signal transformer T2, such as a planar or wire wound transformer, has a primary winding 24 and a secondary winding 26. A first end 28 of the primary winding 24 is connected to the gate of the first primary switching transistor Q1 by a connection 27. A second end 30 of the primary winding 24 is connected to the gate of the second primary switching transistor Q2 by a second connection 32. The first connection 28 and the second connection 32 pass through the core 16 of the power transformer T1. The first and second connections 28, 32 are preferably arranged as a parallel pair 34 through the core 16. The secondary winding 26 of the signal transformer T2 has a first end 36 arranged to determine a control signal input 38 of a synchronous switch Q3. A second end 40 is arranged to determine a control signal input 42 of a freewheeling switch Q4. A circuit of synchronous switch drivers 44 may be connected between the first and second ends 36, 40 and the control inputs 38, 42. The synchronous switch drivers 44 may include a voltage multiplier or other driver circuitry known in the art to apply drive signals to the transistors Q3 and Q4 as is known in the art.

An output side of the power supply 10 has circuitry connected to the secondary winding 14 of the power transformer T1. A first end 46 of the secondary winding 14 is connected to a drain of the freewheeling switch Q4. A source of the freewheeling switch Q4 is connected to a source of the synchronous switch Q3. A drain of the synchronous switch Q3 is connected to a second end 48 of the secondary winding 14. The drain of the freewheeling switch Q4 is connected to one end of an inductor L1. The other end of the inductor L1 is connected to one end of a capacitor C1. The other end of the capacitor C1 is connected to the source of the freewheeling switch Q4 and the source of the synchronous switch Q3. An output voltage +VOUT is taken across the capacitor C1 and provides power to a load represented by a resistor R_{L}. The voltage +VOUT is measured with respect to a reference node −VOUT.

Referring now to FIG. 2 a printed circuit board (PCB) 50 is shown. The PCB 50 has a plurality of footprints formed with solder pads. The solder pads of each footprint are arranged in a pattern that mates with a lead pattern of a device associated with a particular footprint. The plurality of footprints provide attachment points for the several devices of the power supply circuit 10. For example, a footprint 52 provides solder pads for the first primary switching transistor Q1. A second footprint 54 provides solder pads for the second primary switching transistor Q2. A core area 56 is adapted for attachment of the ferrous core 16 and may occupy a width of the PCB 50. A footprint 58 provides solder pads for the transformer T2. A footprint 60 provides solder pads for the transistor Q3. A footprint 62 provides solder pads for the transistor Q4. An area circumscribed by a dotted line 64 provides footprints for components of the primary switch drivers 20. An area circumscribed by a dotted line 66 provides footprints for the synchronous switch drivers 44, the inductor L1, and the capacitor C1. The first connection 27 and the second connection 32 are routed from the solder pads of the footprints 52 and 54 to the solder pads 58 for the transformer T2. The connections 27 and 32 pass through the core area 56 of the transformer T1. The parallel arrangement 34 of the connections 27 and 32 forms a differential input connection to the primary winding 85 of the transformer T2. The differential input arrangement minimizes a coupling of voltages induced by magnetic flux within the core area 56 from undesirably coupling a signal into the connections 27 and 32 and therefore the primary winding of the transformer T2.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A switching power supply circuit comprising:
a first transformer having a core, a primary winding, and a secondary winding;
a first switch having a control signal input and connected to the primary winding of the first transformer;
a synchronous rectifier having a control signal input and connected to the secondary winding of the power transformer;
a second transformer having a primary winding and a secondary winding; and
a first connection having a first end connected to the control signal input of the first switch and a second end connected to the primary winding of the second transformer.

2. The switching power supply circuit of claim 1 further comprising:
a second switch having a control signal input and connected to the primary winding of the first transformer;
a freewheeling switch having a control signal input and being connected to the secondary winding of the first transformer;
a second connection having a first end connected to the control signal input of the second switch and a second end connected to the primary winding of the second transformer.

3. The switching power supply of claim 2 wherein the first and second connections are routed substantially parallel to each other.

4. The switching power supply of claim 3 wherein the first and second connections are also routed through the core of the first transformer.

5. The switching power supply of claim 1 wherein the first connection is routed through the core of the first transformer.

6. The switching power supply of claim 5 further comprising a switch driver circuit connected between the secondary winding of the second transformer and the control signal input of the synchronous rectifier.

7. The switching power supply of claim 1 wherein the first transformer is a planar transformer.

8. The switching power supply of claim 7 wherein the second transformer is a wire wound transformer.

9. A printed circuit board (PCB) comprising:
a power transformer having a primary winding, a secondary winding, and a core region;
a first switch footprint having a first control signal pad and being connected to the primary winding of the power transformer;
a synchronous rectifier footprint having a second control signal pad and being connected to the secondary winding of the power transformer;
a signal transformer footprint having primary winding pads and secondary winding pads; and
a first trace having a first end connected to the first control signal pad and a second end connected to one of the primary winding pads of the signal transformer footprint.

10. The PCB of claim 9 further comprising:
a second switch footprint having a third control signal pad and being connected to the primary winding of the power transformer;
a freewheeling switch footprint having a fourth control signal pad and being connected to the secondary winding of the power transformer; and
a second connection having a first end connected to the third control signal pad of the second switch and a second end connected to the second one of the primary winding pads of the signal transformer footprint.

11. The PCB of claim 10 wherein the first and second connections are routed substantially parallel to each other.

12. The PCB of claim 11 wherein the first and second connections are routed through the core of the power transformer.

13. The PCB of claim 9 wherein the first connection is routed through the core of the power transformer.

14. The PCB of claim 13 further comprising pads for a switch driver circuit connected between the secondary winding pads of the signal transformer and the fourth control signal pad.

15. The PCB of claim 9 wherein the power transformer is a planar transformer.

16. The PCB of claim 15 wherein the signal transformer is a wire wound transformer.

17. A switching power supply circuit comprising:
a first transformer having a core, a primary winding with first and second ends, and a secondary winding with first and second ends;
a first primary switch having a first control signal input and being connected to the first end of the primary winding of the first transformer;
a second primary switch having a second control signal input and being connected to the second end of the primary winding of the first transformer;
a synchronous rectifier having a rectifier control signal input and being connected to the first end of the secondary winding of the first transformer;
a freewheeling switch having a control signal input and being connected to the second end of the secondary winding of the first transformer;
a second transformer having a primary winding with a first end and a second end, and a secondary winding with a first end and a second end;
a first conductor connected between the first control signal input and the first end of the primary winding of the second transformer; and
a second conductor connected between the second control signal input and the second end of the primary winding of the second transformer.

18. The switching power supply of claim 17 wherein the first and second conductors are routed substantially parallel to each other.

19. The switching power supply of claim 18 wherein the first and second conductors route through the core of the power transformer.

20. The switching power supply of claim 17 further comprising a switch driver circuit connected between the first and second ends of the secondary winding of the signal transformer, the rectifier control signal input of the synchronous rectifier, and the control signal input of the freewheeling switch.

21. The switching power supply of claim 17 wherein the first transformer is a power transformer and the second transformer is a signal transformer.
